(19) United States
(12) Patent Application Publication
(10) Pub. No.: US 2023/0324891 A1
(43) Pub. Date: Oct. 12, 2023

(54) METHOD AND SYSTEM FOR AUTONOMOUS PRODUCTION DEVICE MODELING FOR JOB PLANNING IN A PRODUCTION ENVIRONMENT

(71) Applicant: Xerox Corporation, Norwalk, CT (US)

(72) Inventors: Lara Crawford, Belmont, CA (US); Roni Zvi Stern, Modi'in (IL); Wiktor Piotrowski, Redwood City, CA (US); Gregory Michael Youngblood, Las Cruces, NM (US)

(21) Appl. No.: 17/658,382

(22) Filed: Apr. 7, 2022

(51) Int. Cl. G05B 19/418; G06Q 10/06; G06Q 50/04

(52) U.S. Cl. CPC G05B 19/41865; G05B 19/4184; G06Q 10/0631; G06Q 50/04; G05B 2219/32252

(57) ABSTRACT

Systems and methods for generating device profiles of production devices in a production environment are disclosed. The methods include receiving operational data comprising a plurality of data streams generated by the plurality of production devices, training one or more models based on the operational data that are configured to create a device profile for each of the plurality of production devices for use by a job planner and generating the device profile for each of the plurality of production devices. The device profile includes information relating to one or more operational characteristics of that production device.

### BACKGROUND

A typical production environment (e.g., a milling factory, a document processing shop, etc.) consists of a set of machines of one or more types which are used to perform a given sequence of tasks or jobs. To perform a job, the machines in the factory need to perform a set of operations or job functions. Many production factories rely on a job planner—manual or automated—to efficiently allocate jobs to the machines in order to maximize throughput and factory productivity. The goal of the planner is to allocate operations to machines that can perform the allocated operations while aiming to optimize some cost function, e.g., throughput, machine utilization, energy efficiency, cost efficiency, or the like.

Current planning methods and systems require a human to model the capabilities of the machines in the factory, i.e., which operations can be done by which machine and/or the cost of doing so. However, relying on humans to model machine capabilities in a factory has two major limitations. First, modeling by a human is an expensive task that requires sophisticated expertise. Second, the capabilities of a machine may change over time (e.g., due to anomalies, faults, and natural degradation), which in turn requires periodic manual “remodeling” of the factory to account for the changes in the machines' device profiles. As such, having an up-to-date device profile of a system is often prohibitively challenging, and prevent use of model-based approaches to automated planning tasks.

This document describes methods and systems that are directed to solving the issues described above.

### SUMMARY

In various aspects, this disclosure describes a method, a system configured to execute the method, and a computer program product configured to cause a processor to implement a method of generating device profiles of production devices in a production environment. The system may include a processor and a computer-readable medium including programming instructions that when executed by the processor cause the processor the methods. The methods may include receiving operational data comprising a plurality of data streams generated by the plurality of production devices, training one or more models based on the operational data that are configured to create a device profile for each of the plurality of production devices for use by a job planner, and generating the device profile for each of the plurality of production devices. The device profile includes information relating to one or more operational characteristics of that production device. Optionally, the operational data may also include production device configuration information obtained from a manufacturer.

In various implementations, the methods may also include receiving a plurality of jobs for execution in the production environment that each include one or more functions, and causing the job planner to create a job plan for executing each job by correlating device profiles of one or more of the plurality of production devices with functions of that job to create an ordered set of functions to be performed at the one or more of the plurality of production devices. Optionally, the job planner may create the job plan such that the job plan satisfies one or more characteristics of that job. Additionally and/or alternatively, the methods may also include detecting one or more anomalies in a device profile of a production device over time, and updating the job plan to account for the one or more anomalies. An anomaly may be a mismatch between an observed operational characteristic and the device profile of the production device. Optionally, updating the job plan to account for the one or more anomalies can include updating the device profile of the production device.

In one or more embodiments, the one or more models may include, for example and without limitation, machine learning models, statistical models, curve fitting models, parameter-estimation models, logic-based learning models, and/or rule based models.

Optionally, the data streams published by the plurality of production devices may utilize an MTConnect protocol. Additionally and/or alternatively, the data streams published by the plurality of production devices may include time series data observed from each of the plurality production devices including at least one of the following: numeric values or non-numeric values.

In various implementations, the device profile comprising information relating to one or more operational characteristics of that production device may include operation characteristics of that production device as at least one of the following: range values for an operation characteristic, multi-dimensional convex hulls of values of the operational characteristic, multi-dimensional regions of values of the operational characteristic, disjunctions over non-numeric of values of the operational characteristic, operational characteristic patterns in a time series, and/or a mapping of desired operational characteristic of a production device.

### BRIEF DESCRIPTION OF THE DRAWINGS

FIG. 1 illustrates a schematic view of an example production environment.

FIG. 2 illustrates a schematic view of an example system for performing job planning in a production environment.

FIG. 3 is a flow diagram illustrating an example process for performing job planning in a production environment.

FIG. 4 illustrates example components of computing devices that may implement various embodiments described in this document.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such as “first” and “second” are used to modify a noun, such use is simply intended to distinguish one item from another and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

Additional terms that are relevant to this disclosure will be defined at the end of this Detailed Description section.

A “job” refers to a logical unit of work that is to be completed for a customer. For example, in a print production environment, a job may include one or more print jobs from one or more clients. For example, a job in a vehicle production environment may include manufacturing a vehicle or a portion thereof. As another example, a job in a chemical production environment may include producing or processing a chemical product or a portion thereof. Similarly, a job in a computing device production environment may be to manufacture a computing device or a portion thereof such as, for example, a printer, a scanner or a copier.

A “job function” or a “function” refers to one or more processing steps associated with processing a job. In a print production environment, a “print job function” refers to one or more processing steps associated with processing a print job. Example print job functions may include, without limitation, printing, binding, collating, punching, scanning and/or the like.

A “print job” refers to a job processed in a print shop. For example, a print job may include a series of processing steps for producing credit card statements corresponding to a certain credit card company, producing bank statements corresponding to a certain bank, printing a document, or the like. In this document, a print job may refer to the set of instructions that cause the items to be produced or printed, as well as the work-in-progress and produced items themselves. Although the disclosed embodiments pertain to print jobs, the disclosed methods and systems can be applied to jobs in general in other production environments, such as automotive manufacturing, semiconductor production and the like.

A “production device” or “machine” refers to a device that is capable of processing at least a portion of a job. A production device may include one or more electrical, mechanical, and/or electromechanical components configured to perform one or more operations. For example, in a print production environment, an example production device may include, without limitation, a printer, scanner, collator, binder, hole punch and/or the like. Other examples of production devices may include, for example, industrial machines (e.g., milling equipment, mining equipment, construction equipment, factory automation, etc.), medical machines (e.g., medical imaging equipment, surgical equipment, medical monitoring systems, medical laboratory equipment, etc.), or the like. Those of ordinary skill in the art will appreciate that these are but a few examples of assets and that numerous others are possible and contemplated herein.

A “production environment” refers to machine and/or human labor used to complete one or more jobs. A production environment may include one or more production devices or other equipment that may be used to complete one or more jobs. Example production environments may include, without limitation, a print production environment, a chemical production environment, a milling environment, a vehicle production environment, a computing device manufacturing production environment, and/or other manufacturing production environments.

A production environment and the work flowing through it may be modeled to gain an understanding of the production environment's current state. One or more simulations of production environment operations may be performed to determine one or more parameters needed to achieve a desired state. One or more simulations may be used to identify opportunities to increase the overall productivity of production environments through the positioning of production devices and operators, changes in workflow routing, cross-training of production device operators and/or the like.

The term “machine learning model” or a “model” refers to a set of algorithmic routines and parameters that can predict an output(s) of a real-world process (e.g., prediction of a machine's characteristics, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems utilize various types of statistical analyses, machine learning systems are distinguished from statistical analyses by virtue of the ability to learn without explicit programming and being rooted in computer technology.

A typical machine learning pipeline may include building a machine learning model from a sample dataset (referred to as a “training set”), evaluating the model against one or more additional sample datasets (referred to as a “validation set” and/or a “test set”) to decide whether to keep the model and to benchmark how good the model is, and using the model in “production” to make predictions or decisions against live input data captured by an application service.

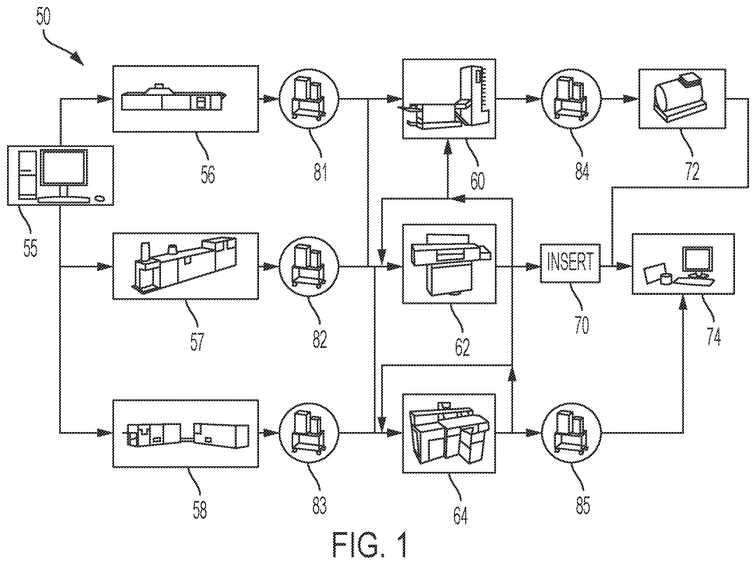

FIG. 1 shows an example of a production environment 50, in this case, example elements of a print shop. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85.

Any now or hereafter known production environments are within the scope of this disclosure such as, without limitation, subtractive manufacturing environments, hybrid subtractive and additive manufacturing environments, print shops, semiconductor manufacturing, chemical productions, or the like.

Make-to-order is a manufacturing process in which manufacturing begins only after an order is received. In a make-to-order production environment, such as a print shop or assembly line productions, jobs may arrive over time. Each job may be defined by certain characteristics such as, for example, an arrival date, a due date, a maximum price, a maximum energy usage, location constraints, one or more functions that are to be performed to complete the job and/or the like.

In an embodiment, a job may be associated with one or more job functions. A job function refers to a processing step that must be completed to process a job. A job function may be an action by which hardware of a production device acts on a workpiece. For instance, with respect to print jobs, example print job functions may include, without limitation, binding, collating, scanning, punching, printing, and/or the like. In certain embodiments, a job may be associated with a sequence of job functions that identify not only the job functions that are to be performed for a job, but also the order in which the job functions are to be performed.

A production environment may include one or more production devices to process the received jobs. Each production device has a set of characteristics such as, for example, the functions it can perform, its processing speed, its setup time, tool type, tool axes, material or substrate types, ranges of motion, patterns of motion, rotation speeds, positioning angular ranges, temperature ranges, pressure ranges, voltage ranges, and/or the like. The current disclosure describes systems and methods for analyzing real-time operational data and/or other information associated with the production devices and autonomously generating a dynamic device profile associated with each of the production devices. A device profile of a production device is a model corresponding to a set of current characteristics or capabilities of the production device C1, C2, . . . , Cn}. In some embodiments, the device profile may include a single model corresponding to one or more capabilities of the production device and/or a plurality of models where each model corresponds to one or more capabilities of the production device. For example, a device profile may include configuration characteristics of a device such as physical parameters (e.g., a range of speeds that the production device can achieve, input power requirements of a production device, range of voltages, range of position angles, range of temperature settings, other parameter ranges, etc.); and/or operational parameters of a production device (e.g., one or more functions the production device can perform, tools used by the production device and corresponding information, setup requirements, availability and/or workloads of a production device, efficiency parameters of a production device, location of a production device in the production environment, energy usage of a production device, patterns of operation of the production device, etc.). In some embodiments, the device profiler 212 may also detect and/or receive the type and/or make of the production devices. The device profiler 212 can simplify the planning process by generating device profiles associated with production devices in a production environment, completely or partially without user input.

Capability modeling methods are often computationally difficult to create, and may yield computational times that are too long to react to real-time demands for scheduling and/or fault diagnostics. The device profile generation methods of this disclosure overcome these and other technical challenges.

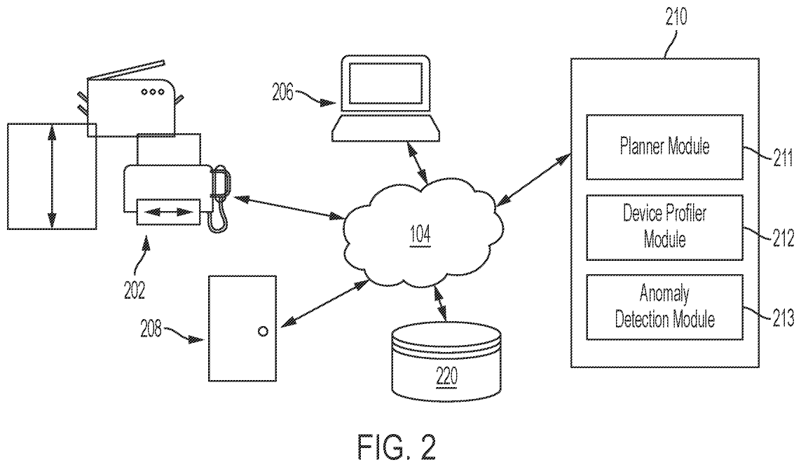

FIG. 2 illustrates a schematic diagram of an example system for performing job planning for a production environment by autonomously modeling capabilities of production devices in the production environment. As shown in FIG. 2, the system 200 includes one or more production devices 202, in communication with the network 204. At least some of the production devices 202 may also be connected to a client device 206 and a production server 208 via the network 204. The system 200 may also include a planning engine 210 and a data store 220.

The production devices 202 may generally be any devices that are included in a production environment and are configured for performing one or more job functions. One or more of production devices 202 may be capable of directly generating and/or receiving communications (e.g., active production devices). However, it is further contemplated that one or more other devices, such as another production device, may generate and/or receive communications on behalf of a production device (e.g., passive production devices).

The production devices 202 may include any number of different types of devices, grouped in various combinations. The production devices 202 may include components such as, without limitation, tools (e.g., cutting, milling, drilling, etc.), printing or scanning components (e.g., toner, print heads, etc.), transport mechanisms (e.g., conveyors, wheels, robotic transport controllers, etc.), automated assembly stations (e.g., robotic assembly), sensors, radio frequency identification (RFID) technology, global positioning system technology, mechanisms for real-time acquisition of data, passive or interactive interface, mechanisms of outputting and/or inputting sound, light, heat, electricity, mechanical force, chemical presence, biological presence, location, time, identity, other information, or the like. In certain embodiments, the production devices 202 may be equipped with various types of sensors to collect information about themselves and their surroundings and provide the collected information to other components of the system 200. Some of the production devices 202 may perform a specified function in response to control commands sent from the client device 206, other production devices 202, the planning engine 210, and/or the production server 208.

The production devices 202 may implement one or more application-layer communication protocols. Examples include constrained application protocol (CoAP), message queue telemetry transport (MQTT), MTConnect, Open Platform Communications (OPC) UA, HTTP, and the like for implementing a respective messaging protocol. Production devices 202 may also implement lower-layer communication protocols which may implement layers of a communication protocol stack lower than the application-layer. Example layers implemented may include one or more of the physical, data link, network, transport, session, internet, and presentation protocols. Example protocols implemented include one or more of: Ethernet, Internet Protocol, Transport Control Protocol (TCP), protocols for the 802.11 standard (e.g., PHY, Medium Access Control, Logical Link Control, and the like), and the like.

The production devices 202 can include one or more passive production devices (in contrast to active production devices) that can be coupled to or otherwise be made part of system 200. Passive production devices may include barcoded devices, Bluetooth devices, radio frequency (RF) devices, RFID tagged devices, infrared (IR) devices, NFC tagged devices, or any other suitable device that can provide its identifier and potentially attributes to another device when queried over a short range interface. Active production devices may detect, store, communicate, act on, and/or the like, changes in attributes of passive production devices. For example, in a print production environment, a collators and/or binders may be passive production devices that each has an RFID tag, barcode, and/or other passive communication interface. An active production device, such as a print device or a multi-function device (MFD), may be equipped with a scanner or reader that can read the RFID tag or barcode to detect when passive production devices have been added or removed therefrom, are within range of the active production device, and/or are otherwise associated with the production device, and may optionally receive and/or transmit one or more signals that relate to the activities or functions performed by the passive production devices. Although the foregoing describes passive production devices as having some form of RFID tag or barcode communication interface, these are merely examples.

The network 204 may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, OPC communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, network 204 may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, OPC, CoAP, REST API, XMPP, or another suitable wired and/or wireless communication method. The network 204 may include one or more switches and/or routers, including wireless routers that connect the wireless communication channels with other wired networks (e.g., the Internet). The data communicated in the network 204 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, MTConnect protocol, OPC protocol, or any other protocol that may be implemented with the production devices 202.

In certain embodiments, one or more of the production devices 202 may also be connected via a local network (not shown here). For example, the local network may be established by a local router or a local switch. For example, the production device 202 may be connected to the client device 206 within a local network.

In certain embodiments, one or more of the production devices may communicate with a client device 206. The client device 206 may be an electronic device, a computing device, a networked device, a mobile device, a tablet, a smartphone, or the like. The client device 206 may be a production device and/or contain functionality to manage one or more production devices, such as the group of production devices 202. The client device 206 may include a user interaction interface to allow a user to control a production device, communicate with a production device and/or to access data from the production device. Optionally, a user may submit a job for execution within a production environment via a client device 206. In some embodiments, the client device 206 may display application output generated by an application remotely executing on a server or other remotely located machine (for e.g., for controlling a production device, communicating with a production device and/or to accessing data from the production device).

In certain embodiments, one or more of the production devices may also communicate with a server 208 via the network 204. For example, a networked lighting system may communicate with a server keeping track of whether lights are on/off. The server 208 may be a production device and/or contain functionality to manage one or more production devices, such as the group of production devices 202. The server 208 may create an interface to allow a user to control, access data and/or to interact with the production devices. The server 208 can be implemented as a plurality of structurally separate servers, or alternately may correspond to a single server. Optionally, the group of production devices 202 may be a peer-to-peer (P2P) network, i.e., they are not connected to a server and may communicate with each other directly. In a peer-to-peer network, service discovery schemes can multicast the presence of nodes, their capabilities, and group membership. The peer-to-peer devices can establish associations and subsequent interactions based on this information. Server 208 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

The system 200 may also include a data store 220 configured to store information (e.g., profile, status, attributes, features, functions, operational logs, etc.) corresponding production devices 202 and certain context relevant entities (e.g., people, places, groups, physical objects, brands, things, or any combination thereof). In an embodiment, the data store 220 may collect and/or probe device information (e.g., profile, status, attributes, etc.) from one or more of the production devices 202, client device 206, server 208, planning engine 210, external sources (such as production device manufacture databases), network traffic, protocols, agents, services and techniques used by the production devices, a user, or the like. Specifically, the data store 220 may be configured to receive analog signals, data streams, and/or network packets, among other examples. This information may be collected be collected passively by, for example, eavesdropping to network traffic (e.g., data transmitted between production devices via an MTConnect protocol); and/or actively by querying the devices either directly or indirectly. For example, data store may store a historical database table which stores communication parameters of past transmissions such as protocol, latency, payload information, whether an acknowledgement was required, payload size, and transmission time) for each message sent over a network connection to and/or from a particular production device.

The data store 220 may include one or more processing components configured to perform one or more operations. Example operations may include compression and/or decompression, encryption and/or de-encryption, analog-to-digital and/or digital-to-analog conversion, filtration, and amplification, among other operations. Moreover, the d data store 220 may be configured to parse, sort, organize, and/or route data based on data type and/or characteristics of the data. In some examples, the data store 220 may be configured to format, package, and/or route data based on one or more characteristics or operating parameters of the production device(s). Moreover, the received data may include certain characteristics, such as a source identifier and a timestamp (e.g., a date and/or time at which the information was obtained). For instance, a unique identifier (e.g., a computer generated alphabetic, numeric, alphanumeric, or the like identifier) may be assigned to each production device. Such identifiers may be operable to identify the production device (or sensor) from which data originates. In some cases, another characteristic may include the location (e.g., GPS coordinates) at which the information was obtained. Data characteristics may come in the form of signal signatures or metadata, among other examples.

In an embodiment, the system 200 may also include a planning engine 210 configured to receive a job from a client device 206 and determine a job plan (e.g., identification of production devices for executing one or more job functions, a workflow as a series of sequential job functions to be performed by the identified production devices for executing a job, etc.) based on automatically generated device profiles of one or more production devices in the production environment. In general, the planning engine 210 may be configured to perform analytics on data received from the data store 220 and/or directly from the production devices 202. Specifically, planning engine 210 may be configured to execute one or more modules, which may each take the form of one or more sets of program instructions store in a data storage (e.g., data store 220). The modules may be configured to facilitate causing an outcome to occur based on the execution of the respective program instructions. An example outcome from a given module may include outputting data into another module, updating the program instructions of the given module and/or of another module, and outputting data to a network interface for transmission to a production device, among other examples. The planning engine 210 may be a standalone device or one of production devices 202, and/or the server 208. The planning engine 210 may be a physical device, a virtual device, or a software application running on a physical device. The planning engine 210 may include a user interface that can output information relating to the production devices 202 and receive input information. The planning engine 210 may also be configured to generally observe, monitor (e.g., attributes, activities, states, etc. of the production devices), control, or otherwise manage various components of the system 200.

The planning engine may include a planner module 211 configured for generating the job plan, a device profiler module 212 for generating the device profiles, and an anomaly detection module 213 for identifying and/or predicting one or more anomalies associated with production devices of the production environment.

The planner module 211 may compile the received job and the learned device profiles of the production devices into a planning problem specified in a standardized planning language (e.g., Planning Domain Description Language (PDDL)), and solve the planning problem using any now or hereafter known planning algorithms. For example, the planner may run a forward-chaining greedy best-first search with a domain-independent relaxation-based heuristic to determine a job plan that satisfies the received job characteristics taking into account generated device profiles of production devices.

The device profiler 212 may identify and/or determine device profiles (e.g., including one or more operational capabilities) of the production devices 202 of the system by analyzing data corresponding to the production devices 202 and/or various other components of the system 200.

In an embodiment, the device profiler 212 uses machine learning to provide higher accuracy while requiring less computing time. The device profiler 212 receives as input a set of operational data for a production device, and outputs a device profile indicative of operational character.

The term “operational data” is used broadly to include various kinds of data usable to determine the device profile, and may include, without limitation, data sent to, received by, and/or related to the production devices. The operation data can be derived from information obtained during the operation of the system as a whole in a production environment (e.g., from data published by or otherwise obtained from the production devices), or it can comprise information that is specifically associated with one or more production devices or machines included with or associated with the production environment (e.g., historical data, user provided data, manufacturer specifications, etc. and obtained from, for example, various databases). Such operational data may be Boolean (e.g., indicating whether the respective device has a particular feature or not), numeric (e.g., as in a network address, a destination address, a sensor value), string (e.g., as in host names, measurement units, user query messages, and user agent fields), or the like. In one embodiment, the operational data may include real-time information from continuous or discrete data streams (such as device sensor data), non-real-time data, user-device interaction dataset, user reporting dataset, manufacturer specifications of production devices, manually provided data, or any combination thereof including metadata thereof. Production devices may transmit operating data continuously, periodically, and/or in response to triggering events (e.g., abnormal conditions).

Some example operational data that can be used for determining the device profile include:
a) Packet information and/or network flow attributes. Information about data packets sent to and/or from production devices, such as, without limitation, packet count, byte count, first packet time, last packet time, payload information, latency, transmission time, format of information included (e.g., Boolean, text, or the like), etc. may be specific to specific types of production devices. For example, a message published by a production device utilizing an MTConnect protocol can include information such as, without limitation, execution time, tool position information, tool number, port count, controller mode, rotary velocity, x-axis position, y-axis position, z-axis position, spindle load, x-axis load, y-axis load, z-axis load, feed rate, feed rate override, spindle speed, spindle speed override, or the like in a standard language format. Additionally and/or alternatively, different devices can have different network flow attributes corresponding to network traffic transmitted and/or received by the device such as transmission rate, transmission format or protocol, DHCP parameters (e.g., fingerprint, default hostnames etc.), or the like.
b) Hardware ID indicators, such as a tool being used.
c) User agent indicators extracted from a header of a HTTP request. User agent indicators include a set of identifiers for the model, operating system or the browser/application that issued the respective request.
d) Network protocol parameters. Network protocols and parameters can be mapped to certain device types and models. For example, Multicast Domain Name System (mDNS) service indicator is a zero-configuration service that resolves hostnames to IP addresses in the absence of a conventional domain name server. Several devices use mDNS to advertise a set of services and ports. Additional classification information may be obtained from the TEXT field. mDNS services are popular among printers, or network attached storages. For example, most printers advertise the service ‘printer’ over mDNS. Similarly, Simple Network Management Protocol (SNMP) parameters, where a device with a SNMP server broadcasts and OID (Object Identifier). The content of various fields can be approximately mapped to certain device types and models.
e) Content of measurements or data from a production device (broadcast or otherwise transmitted) based on a particular time of interest, which may be selected based on a number of factors. In some examples, the particular time of interest may be based on a sampling rate. In other examples, the particular time of interest may be based on the time at which an abnormal-condition indicator is triggered. These can include, for example, location readings, images, videos, temperature readings, speed readings, tool identification, job specifications of a job being processed, energy consumption data, processing time data, alerts, and more. Additionally and/or alternatively, measurement units included in the data received and/or sent by the production device may also be relevant. For example, print devices will send and/or receive data that include image color/intensity units. Similarly, temperature ranges published by a production device may include units such as degree Fahrenheit or Celsius, speed ranges published by a production device may include unites such as m/s, or the like. The units may be indicative of the type of data published by the production device and/or the production device itself.
f) Device configuration information derived from, for example, manufacture databases or user databases. Examples of such data may include, without limitation, configuration characteristics of a device such as ranges on physical parameters (discussed above), operational parameters types of operations performed by the production device, setup requirements, ranges or patterns of motion, types of tools associated with the production a production device category (e.g., printer, thermostat, milling tools, cutting tools, scanner, collator, binder, etc.), a production device manufacturer (e.g., XEROX printer), a hardware model, a functionality (e.g., printing, cutting, drilling, scanning, binding, etc.), software applications used by the production device, type of data transmitted by the production device (e.g., document format, milling speeds, rotational speeds, cutting depth, etc.), type of network protocol used by the production device to communicate, or the like.

In an embodiment, the device profiler 212 may receive the operational data from one or more of the production devices 202, client device 206, server 208, data store 220, external sources (such as production device manufacture databases), network traffic, protocols, agents, services and techniques used by the production devices, a user, or the like. For example, the device profiler 212 may receive the operational data directly from the production devices 202, via reporting from the data store 220, other components of the system, or applications corresponding to the production device 202. The device profiler 212 may also extract operational data from an external source. For example, operational data may be extracted from a device manufacturer database (e.g., device configuration data), a calendar, safety incident reports, maintenance reports, a job workflow, or any combination thereof.

Receiving or harvesting of the operational data may depend on a type of the respective data. For instance, device profiler 212 may extract a user agent indicator from a HTTP request received from a production device. In an embodiment, device profiler 212 may extract network flow information by sniffing data packets sent to and/or from a production device using now or hereafter known methods, such as without limitation, virtual private network (“VPN”). The device profiler 212 may intercept messages offering services and broadcast by the production devices to determine the kind of services and/or protocols the respective devices support. In certain embodiment, the device profiler 212 may use a service discovery tool such as Network Mapper (NMap). In an embodiment, the planning engine 210 may send a probe out to a particular port of a production device and listening for a response to harvest data about network protocols and services or send a probe out to an MTConnect agent and listening for a response to harvest data about MTConnect protocol data, or the like.

It will be understood to those skilled in the art that device profiling may proceed iteratively, since not all operational data may be available at once. Some data types may be relatively easy to acquire, while others may necessitate relatively lengthy procedures, such as handshake message exchanges, negotiations on network configuration parameters, authentication, etc. During iterative device profiling, device profiler 212 may perform a preliminary determination of a device profile according to the currently available data about the respective production device. In response to the preliminary determination, device profiler 212 may request further data until an accurate device profiling of the production device is achieved. Additionally and/or alternatively, device capabilities may change over time and the device profiler 212 may update the device profile of a production device periodically and/or upon occurrence of events such as anomaly diagnosis, etc.

In one or more embodiments, the device profiler 212 may be any now or hereafter known machine learning model (e.g., a neural network, a regression model, deep learning model, or the like). In an embodiment, the device profiler utilizes machine learning to generate a device profile of a production device based on corresponding operational data. As used herein, “deep learning” refers to a form of machine learning that utilizes multiple interconnected neural network layers along with feedback mechanisms or other methods to improve the performance of the underlying neural network. Machine learning models may be trained to learn representations of data using supervised and/or unsupervised learning. From a computational standpoint, the methods used in machine learning involve several mathematical calculations of matrix-to-matrix and matrix-to-vector calculations. The number and nature of these calculations makes them essentially impossible for a human to perform the calculation by-hand or by manual process, within any practical amount of time. In an embodiment, the device profiler may receive a training set of data that includes the training data (e.g., MTConnect packets) published and/or received by the production device of a production environment. The device profiler may then analyze the training data to extract features (or characteristics) corresponding to different types of production devices, and generate device profiles of production devices.

For example, the available operational data may be used as a training dataset, and is represented as a set of time series observed from each production device. Each element in a time series is an n dimensional vector (the “OOC vector”), whose elements are the values of the observed operational characteristics (OOC) of a production device at the given time. For a time series T, T[i] is the i^{th} OOC vector in that time series, and T[i][j] the j^{th} element of that vector. The elements of an OOC vector may include numeric values such as the rotation speed of a machine. The elements of an OOC vector may also include non-numeric values defining the basic machine features, such as for CnC machines: types of swappable tool tips a CnC machine can support, or number of axes. Non-numeric OOCs may also indicate something about the mode of operation, such as which tool tip is currently being used. In various embodiments, the OOC may be chosen, provided, and/or automatically selected by the system to facilitate the planner module in planning one or more jobs. For example, if the planner module is required to output job plans that require device capability information relating to rotational speeds of a particular tool, or energy efficiency; the OOC may be chosen to generate device profiles including such information.

The device profiler 212 may output, for example, and without limitation, capabilities of production devices as range values for an OOC, multi-dimensional convex hulls of OOC values, multi-dimensional regions of OOC values, disjunctions over non-numeric OOC values, or the like.

Capabilities as Ranges of Values for an OOC: In this embodiment, a production device capability is a range of values allowed for one of the OOCs of the production device, e.g., the range of rotation speed values, voltage values, printing speed of a print device, energy consumption values, or the like. The device profile of a production device specifies the allowed range of values for each of the n OOCs of the production device. Correspondingly, the device profiler can learn these values by tracking the min and max values of the production device in the training set. If the allowed values for an OOC do not form a connected interval, the corresponding capability can be modeled as multiple disconnected ranges. The capability learner can learn these ranges by tracking the values of the OOCs in histograms, for example, and then calculating the minimum number of disconnected components required for the model. The job planner may create a job plan by, for example, selecting production devices whose OOC value ranges satisfy the job characteristics.

Capabilities as Multi-Dimensional Convex Hulls of OOC Values: In this embodiment, a machine capability specifies a region of an n-dimensional space defined by all possible combinations of OOC values. This region specifies the allowed combination of OOC values that production device can support. According to such a device profile, the production device can perform an operation if the OOC values it requires are within one of the regions defined by its capabilities. The job planner may create a job plan by, for example, selecting production devices whose OOC regions satisfy the job characteristics.

One way to represent such a device profile is as a set of multi-dimensional planes that represent a convex area. Correspondingly, the device profiler can learn such an area by computing the convex hull of all the OOC vectors seen in the training set by, for example, employing existing techniques for computing convex hulls of a set of n dimensional vectors. If n is large, i.e., there is a large number of OOCs, it may also be desirable to use dimensionality reduction techniques, such as principal component analysis (PCA) or autoencoders, to reduce the size of the space to be modeled. This may be particularly useful in cases where large numbers of the variables are correlated through physical processes (e.g., current and voltage readings). Optionally, a lower dimensionality projection of the OOC vectors may also be applied. The resulting low-dimensional representation can then be used in the device profiler and job planner as discussed above.

Capabilities as Multi-Dimensional Regions of OOC Values: The assumption that the capabilities can be captured as a convex region of the n-dimensional space of OOC vectors may not always be correct. In such example, the training set may indicate that a better device profile can be obtained by splitting the convex hull of the data in the training set into multiple pieces, each modeled as a separate achievable region. The split version can then be tested with the available data to see whether it now accurately represents the capabilities. Optionally, clustering algorithms may be used to cluster the OOC vectors in the training set in regions of the OOC vector space that are not convex at all, e.g., employing various kernels.

A related approach to device profiling is to represent the achievable combinations of OOCs as joint distributions. These distributions can be modeled based on observed data, potentially discounted over time, and approximated so as to be represented in a compact form. To determine whether a particular required set of operational characteristics can be executed on a given production device, the probability density at the point corresponding to that combination can be examined. If it is high, then the production device can achieve that operational characteristic. This approach is similar to the modeling approach using histograms above, but using a joint distribution rather than modeling each OOC independently.

Yet another approach is to represent the capabilities of a production device in a neural network classifier, which would be trained to indicate whether a particular set of values (or time series of values) can be achieved on a given production device. This approach does not provide an explicit representation of capabilities, but instead directly maps the desired behavior to presence or absence of a particular capability of a production device.

Capabilities as Disjunctions over Non-Numeric OOC Values: The non-numeric data in the training set can be considered in a similar manner, modeling capabilities as a set of acceptable combinations of values. For example, if an operational characteristic can take on values “A”, “B”, or “C”, but only takes on value “A” when a second operational characteristic takes on value “a”, and otherwise takes on “B” or “C”, this set of possible combinations can be represented as a disjunction. The corresponding capability learner can employ known algorithms for learning a disjunctive normal form from data. A similar technique of slicing or separating the capability space into multiple regions can be used for this non-numeric data. Models combining numeric and non-numeric data are within the scope of this disclosure.

Capabilities as Patterns in a Time Series: Other machine device profiles and learning algorithms are also possible. These may include other ways of modeling multi-variate specific execution patterns that a production device can perform, and then types of tasks it is suitable for. Correspondingly, methods to implement the capability learner may also include applying other temporal data mining techniques to infer complex patterns observed in the data.

It should be understood that while the current disclosure describes the use of machine learning for determining a device profile, the disclosure is not so limiting and other methods such as statistical methods, curve fitting, parameter-estimation, logic based learning methods, rule based methods, or the like (and corresponding models), used with or without machine learning are within the scope of this disclosure.

Referring back to FIG. 2, the anomaly detection module 213 may analyze a plan or workflow for performing a set of jobs and operation data collected from the system when executing said plan, and provide an output indicating the likelihood that one or more production devices in the production environment is currently experiencing an anomaly. An anomaly typically signifies a mismatch between the actual and modeled machine capabilities. For example, an anomaly detection model may be trained using normal operational training data (i.e., without anomalies) and then used to detect anomalies while analyzing collected operation data. An implementation of such an anomaly detection may include, for example, identifying values of operational characteristics of production device that are inconsistent with the corresponding device profile, detection of anomalies when an operation of a job does not meet the desired functional (e.g., desired part not manufactured properly) or non-functional requirements (e.g., desired part manufactured too slowly).

Optionally, the system (e.g., the anomaly detection module 213) may perform diagnostic functions to determine which capability or characteristic of the production device in the device profile is incorrectly modeled, and the source of the anomaly or mismatch between the actual and modeled capability(ies). The detected anomaly may, in general, be due to a physical change in a production device(s) capabilities, reflecting a fault or device aging, for example, or an error in the device profiling that caused the planning module to assign a job to the production device(s) that it was not capable of executing. Optionally, each diagnosis may be associated with a likelihood score that will help in selection of a particular diagnosis.

An anomaly is simply an exception or deviation from the typical usage (tools, power, speed etc.) and does not necessarily imply a malfunction. For example, machining a new part or using a new tool or working with a new type of material may all be deviations from the previous usage of a machine. However, these are intended (and desired) deviations, but if the power usage is unusually high despite unchanged job parameters then it may point to an underlying condition. In either case, the underlying device profile may be updated to reflect the newly extended or restricted capabilities.

In example embodiments, the diagnostic functions may include model-based diagnosis (MBD) algorithms such as, for example, general diagnostic engine (GDE), which extracts conflicts between the assumed device profile and the detected anomalies, and then identifies diagnoses as hitting sets of these conflicts. A conflict in this case is an operation that was not successfully executed by a production device and the capabilities of that production device, according to which that operation should have been executable by that production device. A diagnosis in this case is one or more capabilities in the device profile that may not reflect correctly the capability of the machine.

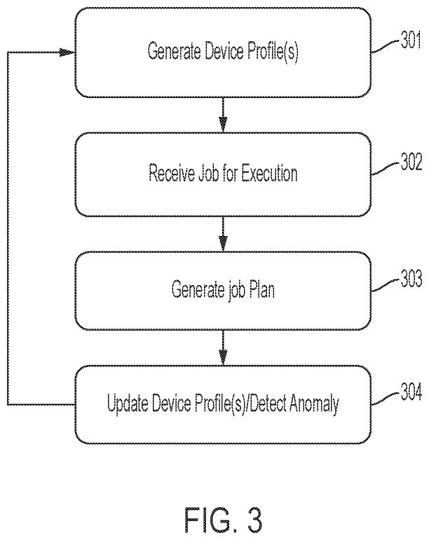

FIG. 3 is a flow diagram illustrating an example process for planning a job by autonomously learning device capabilities of production devices in a production environment. Although this figure depicts steps in a particular sequence for purposes of illustration, the process is not necessarily limited to this particular order or steps. One skilled in the art will appreciate that the various steps portrayed in this figure can be changed, omitted, rearranged, performed in parallel or adapted in various ways.

The system may receive and/or generate device profiles associated with various production devices within the production environment (301). As discussed above, the device profiles may be generated autonomously by analysis of operational data associated with the production devices. Optionally, in various embodiments, the device profiles may correlate to the characteristics of the production device(s) that may be required to execute one or more job functions of the received job.

In an embodiment, the system may receive 302 a job for execution within a production environment. In one embodiment, the job may be received from an external source, such as by email, file transfer or another communications protocol. The job may include various job specifications or characteristics such as, without limitation, an arrival date, a due date, a maximum price, a maximum energy usage, location constraints, one or more functions that are to be performed to complete the job and/or the like.

The system may then use the device profiles to generate a job plan for executing the received job in accordance with the received job characteristics (303). In various embodiments, the job plan can include an identification of one or more production devices that can execute one or more job functions of the received job, and a workflow defining a sequence of executing the job functions and the associated production devices. In general, a workflow may take the form of a series of actions that are carried out based on the device profiles of respective production device. In example implementations, a workflow may include one or more operations that production device performs and is determined based on the generated device profile. For example, the workflow may define a job function to be executed by a production device determined, based on the device profile, to be capable of performing that job function and within the safe operating conditions (e.g., tool speed range) of that production device.

Optionally, a workflow may also include modifying an operating condition of a production device (to, for example, avoid a predicted fault condition, meet certain job specification requirements, etc.). Various operating conditions may be modified, such as a speed, temperature, pressure, fluid level, current draw, and power distribution, among other examples. In a particular example implementation, an operating condition modification workflow may correspond to a device profile for predicting whether a production device will complete a job function on time and may cause the production device to increase its tool speed within a determined operational range.

At 304, the system may continually collect operation data during system operation (e.g., execution of the job, or otherwise) and update the device profiles and/or detect anomalies.

The above process may continue throughout execution of all received jobs. Optionally, the system may provide outputs (e.g., alerts) upon diagnosis of production device faults, changes in a workflow, etc.

Modeling machine capabilities dynamically using real-time operational data, as discussed above, has applications in many production environments. Such job planning allows for capability redundancy where some operations can be performed by more than a single machine. That is, there are redundancies in the set of machines, equipment, or capabilities, available to perform jobs, which can be modeled by the device profile and leveraged by the planning module. Additionally and/or alternatively, the above disclosure allows for use of degraded performance machines (e.g., a machine with fault conditions or health degradations) such that such machines are not necessarily shut down or taken out of operation. Rather, such machines may be intelligently managed and used through factory redundancies for remaining capabilities of the machine (determined based on the device profile), until a suitable repair can be scheduled or a replacement is provided.

In addition, the current disclosure for modeling machine capabilities enables automatic usage analysis and assignment of new jobs to machines, which is useful in production environments that accept a wide variety of customized jobs (allowing on-demand customization and more flexible local manufacturing).

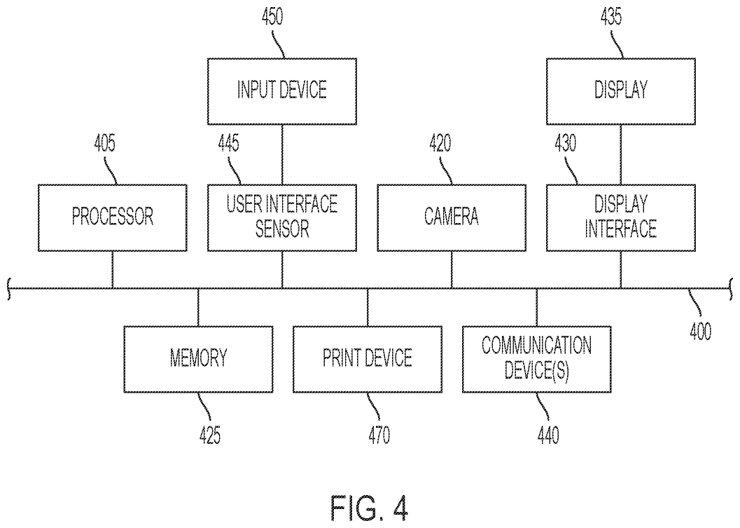

FIG. 4 depicts an example of internal hardware that may be included in any of the electronic components of the system, such as in the print device, in a computing device, etc. One or more conductive buses 400 serve as an information highway interconnecting the other illustrated components of the hardware. Processor 405 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 425. A memory device may include a single device or a collection of devices across which data and/or instructions are stored.

An optional display interface 430 may permit information from the bus 400 to be displayed on a display device 435 in visual, graphic or alphanumeric format. An audio interface and audio output (such as a speaker) also may be provided. Communication with external devices may occur using various communication devices 440 such as a wireless antenna, a radio frequency identification (RFID) tag and/or short-range or near-field communication transceiver, each of which may optionally communicatively connect with other components of the device via one or more communication systems. The communication device 440 may be configured to be communicatively connected to a communications network, such as the Internet, a local area network or a cellular telephone data network.

The hardware may also include a user interface sensor 445 that allows for receipt of data from input devices 450 such as a keyboard, a mouse, a joystick, a touchscreen, a touch pad, a remote control, a pointing device and/or microphone. Digital image frames also may be received from an imaging device 420, such as a camera or scanner, that can capture video and/or still images. The system also may include a print device 470.

Terminology that is relevant to this disclosure includes:

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 4.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, the terms “printer” and “print device” refer to a machine having hardware capable of reading a digital document file and using the information from the file and associated print instructions to print a physical document on a substrate. Components of a print device typically include a print engine, which includes print hardware such as a print head, which may include components such as a print cartridge containing ink, toner or another print material, as well as a document feeding system configured to pass a substrate through the print device so that the print head can print characters and/or images on the substrate. In some embodiments, a print device may have additional capabilities such as scanning or faxing and thus may be a multifunction device. A print device also may include a processor and a memory device containing programming instructions and/or stored data. In embodiments that print a 3D object, the print device may be a 3D printer that can use a digital model to successively place layers of build material on a substrate in a configuration that results in a 3D object.

The features and functions described above, as well as alternatives, may be combined into many other different systems or applications. Various alternatives, modifications, variations or improvements may be made by those skilled in the art, each of which is also intended to be encompassed by the disclosed embodiments.

1. A system for generating device profiles of production devices in a production environment, the system comprising:
a processor; and
a computer-readable storage medium comprising programming instructions that, when executed by the processor, will cause the processor to:
receive, from each of a plurality of production devices in the production environment, operational data comprising a plurality of data streams generated by the plurality of production devices,
train one or more models based on the operational data, wherein the one or more models are configured to create a device profile for each of the plurality of production devices for use by a job planner, the device profile comprising information relating to one or more operational characteristics of that production device, and
generate the device profile for each of the plurality of production devices.

2. The system of claim 1, further comprising programming instructions that, when executed by the processor, will cause the processor to:
receive a plurality of jobs for execution in the production environment, wherein each of the plurality of jobs comprises one or more functions; and
for each of the plurality of jobs, cause the job planner to create a job plan for executing that job by correlating device profiles of one or more of the plurality of production devices with functions of that job to create an ordered set of functions to be performed at the one or more of the plurality of production devices.

3. The system of claim 2, wherein the instructions to cause the job planner to create the job plan for executing that job further comprise instructions to cause the cause the job planner to create the job plan such that the job plan satisfies one or more characteristics of that job.

4. The system of claim 2, further comprising programming instructions that, when executed by the processor, will cause the processor to:
detect, over a period of time, one or more anomalies in a device profile of a production device, an anomaly being a mismatch between an observed operational characteristic and the device profile of the production device; and
update the job plan to account for the one or more anomalies.

5. The system of claim 4, wherein the instructions to update the job plan to account for the one or more anomalies comprise instructions to cause the processor to update the device profile of the production device.

6. The system of claim 1, wherein the one or more models comprise at least one of the following: machine learning models, statistical models, curve fitting models, parameter-estimation models, logic based learning models, or rule based models.

7. The system of claim 1, wherein the data streams published by the plurality of production devices utilize an MTConnect protocol.

8. The system of claim 1, wherein the data streams published by the plurality of production devices comprise time series data observed from each of the plurality production devices including at least one of the following: numeric values or non-numeric values.

9. The system of claim 1, wherein the device profile comprising information relating to one or more operational characteristics of that production device comprise operation characteristics of that production device as at least one of the following: range values for an operation characteristic, multi-dimensional convex hulls of values of the operational characteristic, multi-dimensional regions of values of the operational characteristic, disjunctions over non-numeric of values of the operational characteristic, operational characteristic patterns in a time series, or a mapping of desired operational characteristic of a production device.

10. The system of claim 1, wherein the operational data further comprises production device configuration information obtained from a manufacturer.

11. A method for generating device profiles of production devices in a production environment, the method comprising, by a processor:
receiving, from each of a plurality of production devices in the production environment, operational data comprising a plurality of data streams generated by the plurality of production devices,
training one or more models based on the operational data, wherein the one or more models are configured to create a device profile for each of the plurality of production devices for use by a job planner, the device profile comprising information relating to one or more operational characteristics of that production device, and
generating the device profile for each of the plurality of production devices.

12. The method of claim 11, further comprising, by the processor:
receiving a plurality of jobs for execution in the production environment, wherein each of the plurality of jobs comprises one or more functions; and
for each of the plurality of jobs, causing the job planner to create a job plan for executing that job by correlating device profiles of one or more of the plurality of production devices with functions of that job to create an ordered set of functions to be performed at the one or more of the plurality of production devices.

13. The method of claim 12, wherein causing the job planner to create the job plan for executing that job comprises causing the job planner to create the job plan such that the job plan satisfies one or more characteristics of that job.

14. The method of claim 12, further comprising, by the processor:
detecting, over a period of time, one or more anomalies in a device profile of a production device, an anomaly being a mismatch between an observed operational characteristic and the device profile of the production device; and
updating the job plan to account for the one or more anomalies.

15. The method of claim 14, wherein updating the job plan to account for the one or more anomalies comprises updating the device profile of the production device.

16. The method of claim 11, wherein the one or more models comprise at least one of the following: machine learning models, statistical models, curve fitting models, parameter-estimation models, logic based learning models, or rule based models.

17. The method of claim 11, wherein the data streams published by the plurality of production devices utilize an MTConnect protocol.

18. The method of claim 11, wherein the data streams published by the plurality of production devices comprise time series data observed from each of the plurality production devices including at least one of the following: numeric values or non-numeric values.

19. The method of claim 11, wherein the device profile comprising information relating to one or more operational characteristics of that production device comprise operation characteristics of that production device as at least one of the following: range values for an operation characteristic, multi-dimensional convex hulls of values of the operational characteristic, multi-dimensional regions of values of the operational characteristic, disjunctions over non-numeric of values of the operational characteristic, operational characteristic patterns in a time series, or a mapping of desired operational characteristic of a production device.

20. The method of claim 11, wherein the operational data further comprises production device configuration information obtained from a manufacturer.
